(19) United States
(12) Patent Application Publication
(10) Pub. No.: US 2021/0273339 A1
(43) Pub. Date: Sep. 2, 2021

(54) Wideband Dual-Polarized Four-Quad Loop Antenna

(71) Applicant: Massachusetts Institute of Technology, Cambridge, MA (US)

(72) Inventors: Alan J. FENN, Wayland, MA (US); Walter F. DAVIDSON, Hudson, NH (US)

(21) Appl. No.: 16/096,458

(22) PCT Filed: Sep. 18, 2018
(86) PCT No.: PCT/US2018/051470

§ 371 Date: Oct. 25, 2018

(51) Int. Cl. H01Q 9/26; H01Q 21/26; H01Q 1/52; H01Q 1/48; H01Q 7/00; H01Q 21/00

(52) U.S. Cl. CPC H01Q 9/265; H01Q 21/26; H01Q 21/0006; H01Q 1/48; H01Q 7/00; H01Q 1/523

(57) ABSTRACT

Described herein is wideband dual-polarized, four-quad-loop antenna suitable for use at VHF/UHF one embodiment with center frequency of 245 MHz had a bandwidth of 170 MHz to 320 MHz band (61% instantaneous bandwidth).

### BACKGROUND

As is known in the art, dual-polarized antennas capable of operation in the frequency range of about 30 MHz to about 300 MHz (i.e. the very high frequency (VHF) band as defined by the Institute of Electronic & Electrical Engineers (IEEE) and the International Telecommunications Union (ITU)) are desired for use in systems capable of operating in transmitting and receiving modes.

As is also known, prior art attempts to provide dual-polarized antennas capable of wideband operation use continuous electrically conducting squares or other shapes of flat plates.

### SUMMARY

Described herein is a dual-polarized, four-quad loop antenna capable of operating in the very high frequency (VHF) and ultra-high frequency (UHF) band and having a relatively high gain characteristic, a low cross polarization characteristic, and low voltage standing wave ratio (VSWR) characteristic over at least a portion of the VHF and or UHF band. In one embodiment a dual-polarized, four-quad loop antenna provides such gain, cross-polarization and VSWR characteristics over a frequency range from about 170 MHz to about 320 MHz (i.e. a center frequency 245 MHz and an approximately 61% bandwidth within the VHF band). Thus, the dual polarized, four-quad loop antennas provided in accordance with the concepts described herein has one or more of the above-noted improved characteristics over a relatively wide bandwidth within the VHF band. Such an antenna is capable of operation in transmitting and/or receiving modes and suitable for use in a ground-based system.

In embodiments, a wideband dual-polarized four-quad-loop antenna suitable for ground-based use in the frequency range of about 170 MHz to about 320 MHz (about 61% instantaneous bandwidth) is described. In embodiments, such a dual-polarized four-quad-loop antenna has performance characteristics of peak realized gain >6 dBi, VSWR <2.5:1, and cross polarization <−20 dB over this bandwidth.

In embodiments, the antenna comprises four square loops (i.e. a quad-loop antenna) provided from tubing. In embodiments, the tubing is provided having a circular or square cross-sectional shape. The quad-loops are driven in two independent pairs through a pair of folded coaxial baluns. With this arrangement, the antenna effectively produces radiation patterns which are the same as or similar to radiation patterns produced by a crossed dipole antenna. In embodiments, the quad loop antenna may be provided from relatively thin tubular structures. By providing the quad loop antenna from relatively thin tubular structures, the quad loop antenna is light weight and capable of operating in high wind conditions (i.e. the antenna is provided having physical characteristics which allows the antenna to operate in environments having relatively high wind conditions).

In accordance with one aspect of the concepts described herein, an antenna system includes an electrically conducting ground plane, a plurality of loop antenna elements disposed above the ground plane and a like plurality of folded coaxial baluns comprising coaxial transmission lines each having a first end with a center conductor electrically coupled to a corresponding one of said plurality of loop antenna elements and a second end having an outer conductor electrically coupled to said ground plane such that the antenna system is capable of transmitting and/or receiving radio frequency (RF) electromagnetic waves.

With this particular arrangement, an antenna system capable of operating in the very high frequency (VHF) band and having a relatively high gain characteristic, a low cross polarization characteristic, and a relatively low voltage standing wave response (VSWR) characteristic over at least a portion of the VHF band is provided.

In embodiments, the antenna system is configured for operation in the VHF frequency range with a center frequency of about 245 MHz and bandwidth of about 150 MHz. However, it should be appreciated that the designs described herein are scalable over at least the VHF and UHF bands.

In embodiments, the plurality of antenna elements are four antenna elements each of which may be provided as a square-shaped antenna element or a circular or partially circular-shaped antenna element and the plurality of folded coaxial baluns are a pair of folded coaxial baluns with each of the folded baluns having a first end coupled to corresponding ones of the antenna elements and a second end coupled to the ground plane.

In embodiments, the system further comprises a pair of cross-connect feed members. Each cross-connect member is coupled to a folded coaxial balun. Each folded coaxial balun is composed of a coaxial transmission line section and an electrically conducting tube or rod section. In embodiments, the coaxial line and conducting tube sections are arranged in parallel. The conducting rod together with the outer conductor of the coaxial section acts as an open-wire balanced transmission line, that is approximately one-quarter wavelength long at the center operating frequency and is electrically connected to the ground plane. The open-wire folded balun presents a relatively large impedance at a feed region to reduce (and ideally prevent) significant current flow on the outer surfaces of the balun. The open-wire balanced transmission line (balun) is electrically connected to opposing loop elements such that the opposing loops are fed in a differential (plus minus) balanced mode. One end of the cross-connect member is electrically connected to the center conductor of the coaxial feed line and the other end is electrically connected to the opposing loop and second section of the open-wire balanced transmission line. The second cross-connect member is electrically isolated from the first cross-connect member such that the four-quad-loop antennas are capable of being driven in two independent pairs from the pair of folded coaxial baluns.

In embodiments, the ground plane is provided as a mesh ground plane or a solid ground plane.

In embodiments, the loop elements are provided from an electrically conductive material.

In embodiments, the loop antenna elements are comprised of at least one of: electrically conducting wire; tube-shaped antenna elements; or strip antenna elements.

In embodiments, the loop antenna elements have a perimeter approximately 0.7 wavelengths long a center operating frequency of a transmit and/or receive system.

In embodiments, the loop antenna elements have an approximate square or circular shape.

In embodiments, the loop antenna elements are spaced approximately 0.25 wavelengths above a surface of a ground plane at a center operating frequency of a transmit and/or receive system.

In embodiments, the antenna system includes four loop antenna elements and dual folded coaxial baluns, which provide an impedance match from a transmission line to the loop antenna elements.

In embodiments, the antenna system is configured to provide two independent orthogonal linear polarizations, which can be combined using couplers to produce a single linear polarization, circular polarization or elliptical polarization.

In embodiments, the antenna system is configured to provide a high front to back ratio characteristic.

In embodiments, the antenna system is configured to provide a high polarization ratio characteristic for dual-polarization frequency reuse.

In embodiments, the antenna system can be used in communications, radar, radio astronomy, and other sensing applications.

### BRIEF DESCRIPTION OF THE DRAWINGS

The foregoing features may be more fully understood from the following description of the drawings in which:

FIG. 1 is a block diagram of a transmit-receive system capable of operation in the very high frequency (VHF) band;

FIG. 2. is an isometric view of a dual-polarized, four-quad loop antenna disposed over a mesh ground plane;

FIG. 2A is a top view of the dual-polarized, four-quad loop antenna of FIG. 2;

FIG. 2B is a side view of the dual-polarized, four-quad loop antenna of FIG. 2;

FIG. 2C is an expanded isometric view of a portion of the dual-polarized, four-quad loop antenna of FIG. 2 taken across lines 2C-2C of FIG. 2;

FIG. 2D is an expanded side view of a portion of the dual-polarized, four-quad loop antenna of FIG. 2C;

FIG. 3 is a side view of a crossover feedbar of the type which may be used in the dual-polarized, four-quad loop antenna of FIG. 2;

FIG. 3A is an end view of the crossover feedbar of FIG. 3;

FIG. 3B is a top view of the crossover feedbar of FIG. 3;

FIG. 4. is a side view of a folded balun coupled to a mounting plate for use with a dual-polarized, four-quad loop antenna of the type which may be the same as or similar to the dual-polarized, four-quad loop antenna of FIG. 2;

FIG. 4A. is a top view of the mounting plate shown in FIG. 4;

FIG. 5 is a diagram of a dual-polarized, four-quad loop antenna of the type described above in conjunction with FIGS. 2-2D excited so as to generate radio frequency (RF) signals having a horizontal polarization characteristic;

FIG. 5A is a diagram of a dual-polarized, four-quad loop antenna of the type described above in conjunction with FIGS. 2-2D excited so as to generate RF signals having a vertical polarization;

FIG. 5B is a diagram of a dual-polarized, four-quad loop antenna of the type described above in conjunction with FIGS. 2-2D excited so as to generate RF signals having a slant left linear polarization characteristic;

FIG. 5C is a diagram of a dual-polarized, four-quad loop antenna of the type described above in conjunction with FIGS. 2-2D excited so as to generate RF signals having a slant right linear polarization characteristic;

FIG. 6 is a plot of reflection coefficient vs. frequency for both measured and simulated reflection coefficient for a dual-polarized, four-quad loop antenna of the type described above in conjunction with FIGS. 2-2D;

FIG. 6A is a plot of mismatch loss vs. frequency for both measured and simulated mismatch loss for a dual-polarized, four-quad loop antenna of the type described above in conjunction with FIGS. 2-2D;

FIG. 6B is a plot of voltage standing wave ratio (VSWR) for both measured and simulated VSWR for a dual-polarized, four-quad loop antenna of the type described above in conjunction with FIGS. 2-2D;

FIG. 7 is a plot of gain vs. frequency comparing simulated and measured boresight gain from H-plane measurements for a dual-polarized, four-quad loop antenna of the type described above in conjunction with FIGS. 2-2D;

FIG. 8 is a plot of gain vs. azimuth which illustrates boresight gain of measured HH (E-plane), HV, VH, W (H-plane) gain patterns at a frequency of 200 MHz for a dual-polarized, four-quad loop antenna which may be the same as or similar to the dual-polarized, four-quad loop antenna of FIGS. 2-2D; and

FIG. 9. is an isometric view of an alternate embodiment of a four-quad loop antenna disposed over a ground plane.

### DETAILED DESCRIPTION

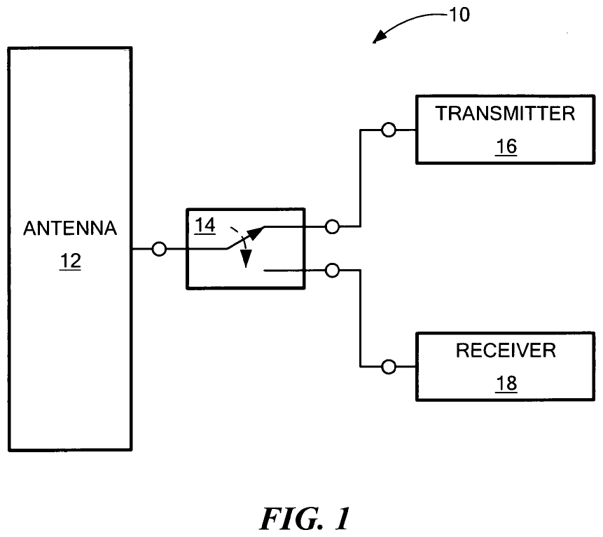

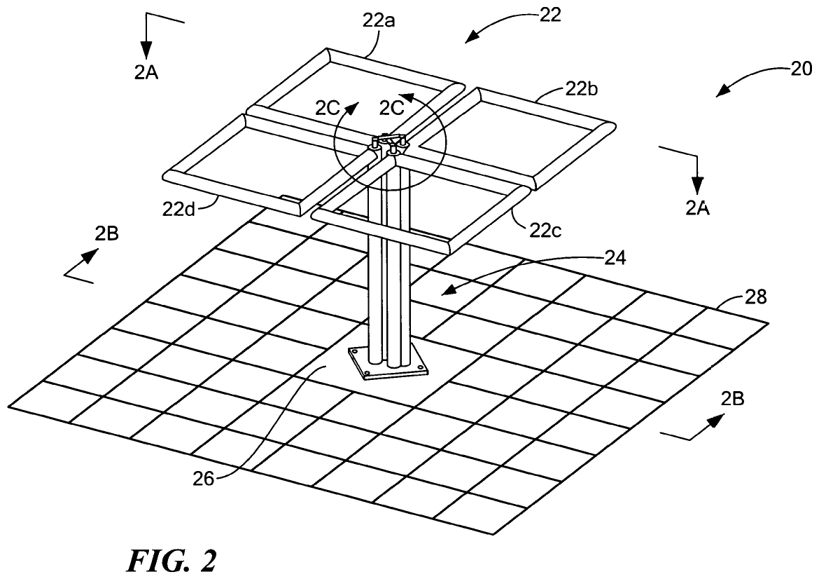

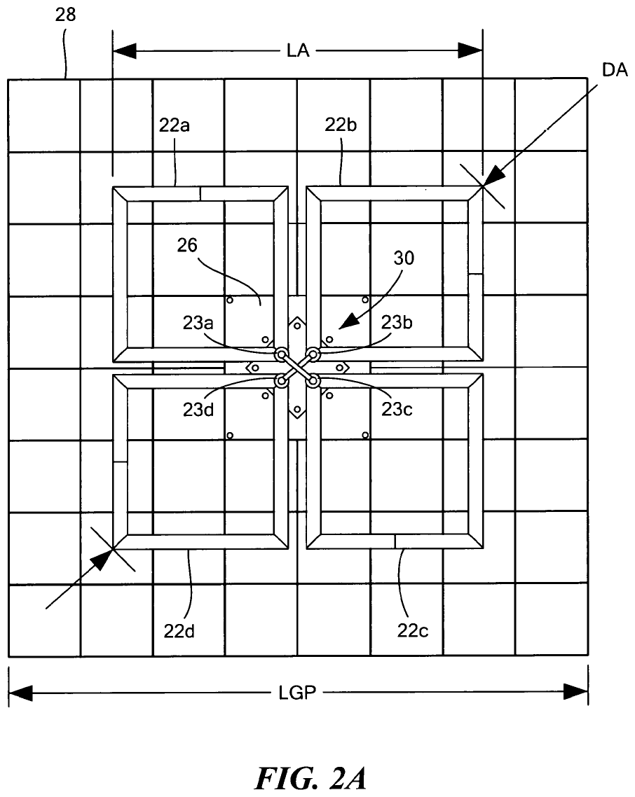

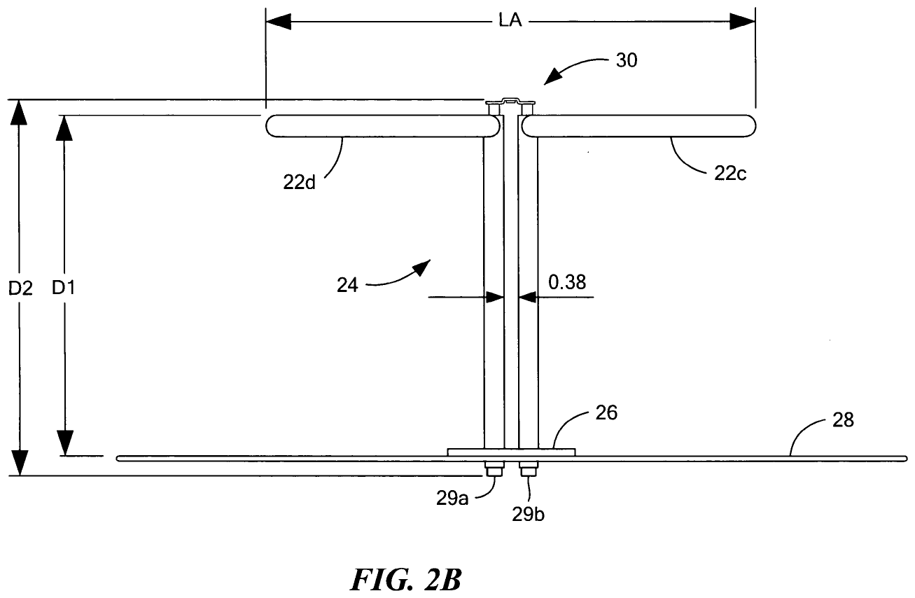

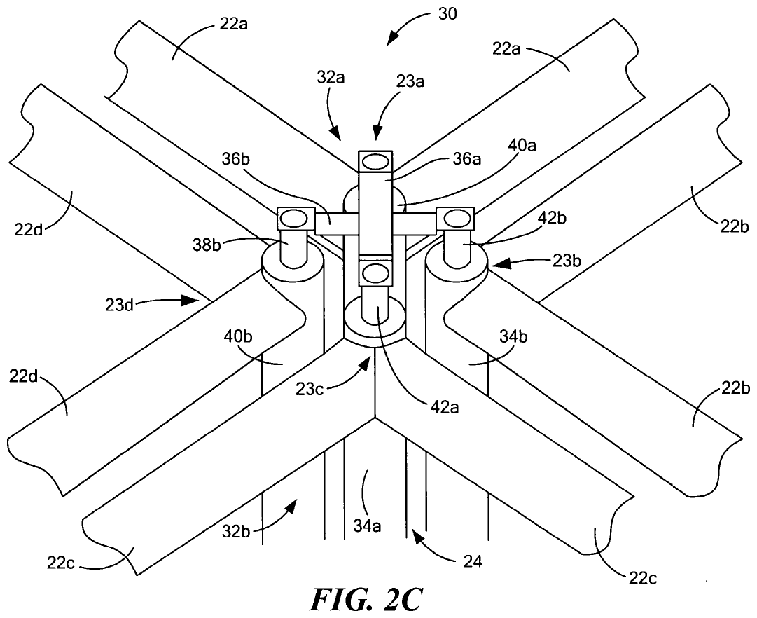

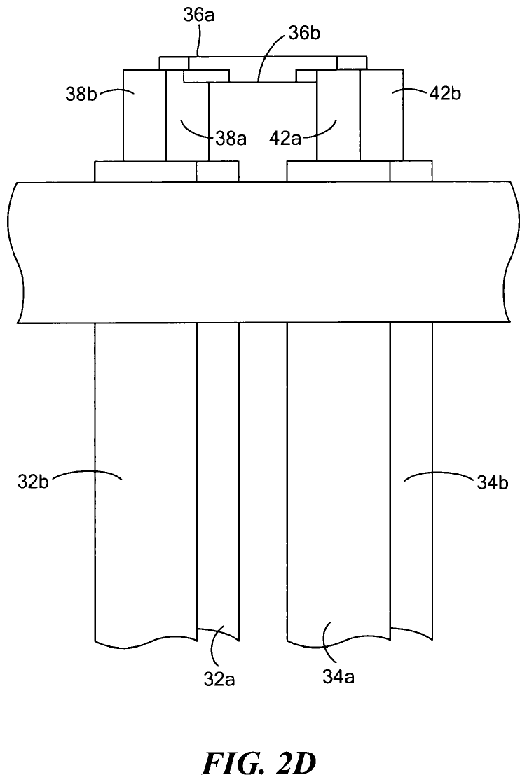

Referring now to FIG. 1, a transmit and receive system 10 includes a dual-polarized, four-quad loop antenna 12 coupled through a transmit-receive (T/R) switch 14 to a transmitter 16 and a receiver 18. T/R switch 14, transmitter 16 and receiver 18 operate in a conventional matter. The dual-polarized, four-quad loop antenna 12, may be the same as or similar to the dual-polarized, four-quad loop antenna described in detail below in conjunction with FIGS. 2-8. Suffice it here to say that dual-polarized, four-quad loop antenna 12 is suitable for operation in at least the very high frequency (VHF) band. Similarly, switch 14, transmitter 16 and receiver 18 are also configured to be suitable for operation in the VHF band. Thus, each of the components 12, 14, 16, 18 (and accordingly transmit and receive system 10 itself) are suitable for use in systems capable of operation in both transmit and receive modes in the VHF band.

It should be appreciated that T/R switch 14 may be replaced by any component capable of separating transmit and receive signals such that system 10 is capable of operating in both a transmit and a receive mode. Furthermore, although antenna 12 is capable of both transmitting and receiving VHF signals, in some embodiments, separate transmit and receive antennas may be used. In this case, a first (or transmit) antenna which may be the same as or similar to antenna 12 may be coupled directly to transmitter 16 and a second (or receive) antenna may be coupled directly to the receiver 18.

Referring now to FIGS. 2-2D in which like elements are provided having like reference designations throughout the several views, a dual-polarized, four-quad loop antenna assembly 20 comprises an antenna 22 provided from four loops 22a-22d. Loops 22a-22d correspond to individual radiating sections of antenna 22. Each of the loops 22a-22d is coupled to a first end of a respective one of a pair of folded baluns 24. A second end of folded balun 24 is coupled to a mounting plate 26. Details of the folded baluns 24 as well as the particular manner in which loops 22a-22d are coupled to the folded baluns 24 will be described in detail below in conjunction with at least FIGS. 2B-2D. Suffice it here to say that folded baluns 24 allow signals in the VHF/UHF band to be provided to and received from antenna 22 and enables excitation of antenna 22 in desired polarizations via signals provided thereto through folded baluns 24.

Antenna 22 is disposed over a conductive surface 28 which serves as a ground plane 28. In this illustrative embodiment, conductive surface 28 is provided having one or more openings therein so as to form a so-called “mesh” ground plane. Here, mesh ground plane 28 is provided from a plurality of conductive strips (e.g. wires or other conductive structures) and thus ground plane 28 is here illustrated as a wire mesh ground plane. In other embodiments, ground plane 28 may be provided from a conductive surface having only one opening therein and in still other embodiments, ground plane 28 may be provided as a solid conductive surface (i.e. a conductive surface having no openings therein). In any event, regardless of the number of openings formed or otherwise provided in conductive surface 28, the conductive surface 28 serves as a ground plane for antenna assembly 20.

As depicted in the illustrative embodiment of FIGS. 2-2D, antenna 12 may be fabricated or otherwise provided from tubular structures. In embodiments, the tubular structures may be provided to promote operation in certain environments (i.e. structures having diameters and/or shapes selected to allow the antenna to operate in desired environmental conditions). When fabricated or otherwise provided from relatively thin tubular structures, the antenna assembly 20 is light weight and is capable of operation in an environment in which high wind conditions exist (e.g. winds in excess of about 40 mph). Embodiments have operated in winds in excess of 60 MPH. Thus, some or all of the structures from which the antenna is provided (including the loops) may have diameters and/or shapes selected to allow the antenna to operate in desired environmental conditions. For example, in embodiments in which the antenna is intended to operate in high wind conditions, the structures are provided having shapes (including, but not limited to cross-sectional shapes) selected to reduce surface area and avoid wind loading. Other mechanical considerations (e.g. materials from which the structure are provided) may also be taken into account.

In the illustrative embodiment of FIGS. 2-2D, antenna loops 22a-22d are provided from tubular structures having a circular (or generally circular) cross-sectional shape, solid or hollow. Those of ordinary skill in the art will appreciate, of course, that such tubular structures may also be provided having other cross-sectional shapes, including but not limited to: right-angle-stock, oval, square, rectangular, triangular or any regular or irregular cross-sectional shape. After reading the disclosure provided herein, those of ordinary skill in the art will appreciate how to select a particular cross-sectional shape for use in a particular application. It should, of course, be appreciated that the size of the loop elements is selected so as to be compatible with the size of the balun tube diameter. In embodiments, the diameter and cross-sectional shape of the members from which the loops are formed or otherwise provided are chosen according to mechanical considerations for durability when operating under high-wind conditions. In some instances, electrical performance considerations may be taken into account.

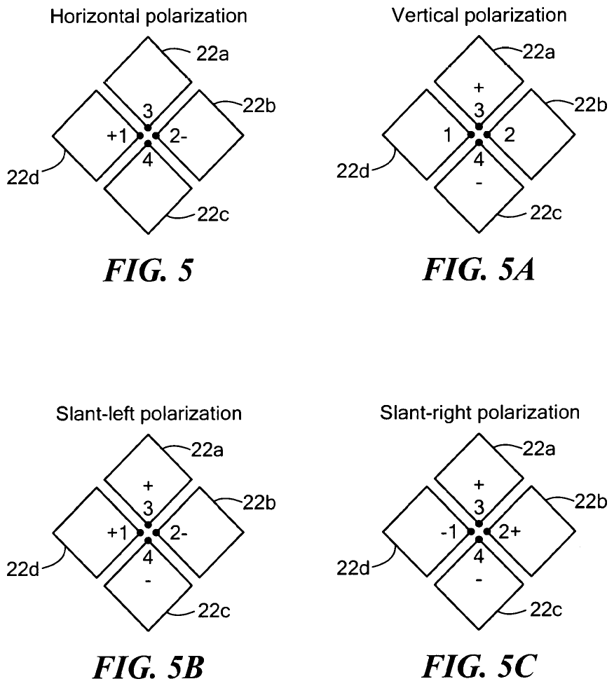

As may be most clearly seen in FIG. 2A, in the illustrative embodiment of FIGS. 2-2D, loops 22a-22d of the illustrative antenna 22 are provided as four substantially identical loop sections or quadrants 22a-22d (hence the name four-quad loop antenna). As will be described in detail in conjunction with FIGS. 5-5C below, centrally located corners 23a-23d of the four loops 22a-22d are used in exciting the desired polarizations via signals provided thereto through the pair of folded baluns 24.

As may also be most clearly visible in FIG. 2A, the illustrative dual-polarized, quad-loop antenna 22 is provided having a square shape with side dimensions of LA and a diagonal length of DA. Further, the ground plane is also provided having a square shape having a length LGP. In one illustrative embodiment for operation in the VHF band, the side dimension LA of the overall dual-polarized, quad-loop antenna is 18.53″ and the diagonal length DA is 26.21′ and the mesh ground plane length LGP is 30″.

It should be noted that in the illustrative embodiment of FIGS. 2-2D, the antenna assembly 20 (comprised of antenna 22 and folded baluns 24) is coupled to a mounting plate 26 which enables the antenna to be mounted on a ground plane (e.g. ground plane 28) having any arbitrary shape. In the illustrative embodiment of FIGS. 2-2D, the mounting plate is provided as an aluminum subplate (base) having a square shape. Those of ordinary skill in the art will appreciate of course, that in some embodiments mounting plate 26 may be provided having any shape including arbitrary shapes and may be made from any electrically conductive material. In some embodiments, mounting plate 26 may be omitted and baluns 24 may be mounted or otherwise coupled directly to ground plane 28 using any permanent or releasable fastening techniques and systems known to those of ordinary skill in the art including, but not limited to welding, brazing, bolts and conductive epoxies or glues.

In one illustrative embodiment for operation in the VHF band, each of the four loops 22a-22d is provided from aluminum tubing having a circular cross-sectional shape having an outside diameter (OD) of 0.75″ and the side of each loop (i.e. ½ LA) is 9.0″. It should be noted that a gap exists between the loops.

As may be most clearly seen in FIG. 2B, the loops 22a-22d are disposed a distance D1 above the ground plane 28. In preferred embodiments the distance D1 is approximately one-quarter wavelength (λ/4) at a desired operating frequency or at a frequency which is substantially in the center of a desired range of operating frequencies. In one illustrative embodiment for operation in the VHF band (e.g. at a frequency of 245 MHz), the 245 MHz distance D1 is 12.9″ (i.e. a top-most surface of loops 22a-22d are spaced 12.9″ above a top surface of the ground plane 28) and a distance D2 from an end surface of balun 24 to a top surface of feed 30 is 14.24″. The one-quarter wavelength distance from the loops to the ground plane is chosen to provide maximum gain. It should be appreciated that in other embodiments, it may be desirable or even necessary, to use a different spacing D1 (i.e. either greater than or less than λ/4 spacing) so as to enhance or optimize an antenna characteristic other than gain. In embodiments, both electrical and mechanical considerations may come into consideration (such as an available space within which the antenna must fit).

Connectors 29a, 29b are coupled to ends of the coaxial transmission lines. In embodiments, connectors 29a and 29b are provided as microwave coaxial connectors (type-N). Other types of connectors (including specially designed connectors) may, of course, also be used. After reading the description provided herein, one of ordinary skill in the art will understand how to select a connector for a particular application. Factors to consider in selecting a connector include, but are not limited to: frequency of operation, operating power levels and available space.

Referring now to FIG. 2C, a feed region 30 of antenna 20 includes a pair of folded baluns 24 provided from a pair of coaxial feed lines 32a, 32b (i.e. coaxial transmission lines) and a pair of conductive rods 34a, 34b. Each coaxial transmission line 32a, 32b has a respective center (or inner) conductor 38a, 38b and an outer conductor 40a, 40b (also sometimes referred to as jackets or shields). Respective ones of coaxial transmission lines 32a, 32b are electrically coupled to a respective one of conductive rods 34a, 34b via a respective one of cross members 36a, 36b. A first one of the center conductors, here center conductor 38a, is electrically coupled to a first one of the conductive rods, here conductive rod 34a, and a second one of the center conductors, here center conductor 38b, is electrically coupled to a second one of the conductive rods, here conductive rod 34b.

In embodiments, coaxial transmission lines 32a, 32b may also include one or more dielectric support structures (not shown) which mechanically/support the center conductors 38a, 38b within the outer conductors 40a, 40b. In some embodiments, the coaxial center conductor is supported at the feed terminals with a Rexolite cap. Other support structures (in the same or a different position) may, of course, also be used.

In embodiments, the coaxial transmission lines 32a, 32b are provided having dimensions such that the coaxial feed line baluns provide a 50 ohm characteristic impedance transmission line feed. In embodiments, center conductors 38a, 38b may be provided having a tapered shape to provide a smooth mechanical and electrical transition to/from a center pin of a connector coupled to the coaxial line. In embodiments, a type-N microwave connector may be coupled to one end of each coaxial line 32a, 32b to facilitate coupling of signals to/from coaxial lines 32a, 32b.

For example, a type-N microwave connector may be coupled to a first end of one or both of coaxial lines 32a, 32b. A second end of coaxial lines 32a, 32b is coupled to a feed point of a dual-polarized, quad-loop antenna (e.g. one of feed points described in conjunction with FIGS. 5-5C. In a transmit mode of operation, a VHF signal may be fed from a transmitter (or other signal source) through the type-N microwave connector to one or both of coaxial lines 32a, 32b. The VHF signal propagates through the one or both of coaxial lines 32a, 32b and is subsequently coupled to the antenna at the feed points. Similarly, in a receive mode of operation, a VHF signal may be coupled from the one or more feed points of the dual-polarized, quad-loop antenna to one or both of coaxial lines 32a, 32b. The VHF signal propagates through the one or both of coaxial lines 32a, 32b and is subsequently coupled through the type-N microwave connector.

As noted above, in embodiments, center conductors 38a, 38b are electrically coupled to the respective conductive rods 34a, 34b via respective ones of cross-members 36a, 36b. In particular, center conductor 38a is coupled to a post 42a projecting from an end of conducting rod 34a and center conductor 38b is coupled a post 42b projecting from an end of conducting rod 32b. Cross-members 36a, 36b also mechanically couple center conductors 38a, 38b (and thus coaxial transmission lines 32a, 32b) to the respective conductive rods 34a, 34b.

As noted above, cross-members 36a, 36b are capable of electrically coupling center conductors 38a, 38b to respective ones of conductive rods 34a, 34b. In embodiments, cross-members 36a, 36b are provided from electrically conductive materials, and are provided having a size and a shape such that conductive portions of cross-members 36a, 36b are not in physical or electrical contact with each other (i.e. cross-member 36a is not in electrical contact with cross-member 36b). In embodiments, portions of cross-members may be provided having one or more electrically non-conductive surfaces which may be in contact.

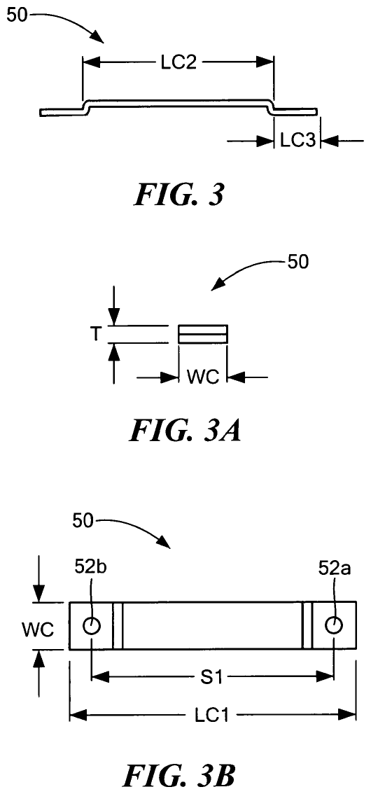

As may be most clearly seen in FIG. 2C, two crossover bars 36a, 36b provide the necessary electrical connections at the feed terminals at the top of the quad loop antenna. An illustrative crossover bar will be described in detail below in conjunction with FIGS. 3-3B. Suffice it there to say that each crossover bar 36a, 36b electrically couples a center conductor to a first end of a conductive rod 34a, 34b. The conductive rod has a second end which is electrically coupled to ground. Conductive rods 34a, 34b may be electrically coupled to ground by coupling a surface of one or both of the conducive rods either directly or indirectly to a surface of the ground plane.

It should be appreciated that a dual-polarized, quad-loop antenna provided in accordance with the concepts described herein is fully scalable over frequency. For example, the antenna may be scaled for operation in any portion of at least the VHF or UHF frequency bands.

It should also be appreciated that the spacing between surfaces of the loops (e.g. loops 22a-22b) as well as the spacing between the feedlines (i.e. coaxial lines 32a, 32b as well as conductive rods 34a, 34b) affects the amount of RF power which a transmitter (e.g. transmitter 16 in FIG. 1) may provide to the dual-polarized, quad-loop antenna. The greater the spacing between loop surfaces, the higher the power of an RF transmit signal which the antenna can accept. There is, of course, a trade-off between the spacing between loops and antenna performance characteristics.

It should be noted that when starting with a pair of loop elements, the antenna performance is narrowband in terms of realized antenna gain. In accordance with the concepts described herein, however, the addition of two additional elements (to arrive at a total of four loops) resulted in increased antenna performance. For example, desired improvements in antenna bandwidth, realized gain, and cross-polarization isolation were achieved by adding additional antenna elements. This improved performance with added antenna elements is attributed to mutual coupling effects that provide wideband tuning of the antenna input impedance.

Referring briefly to FIGS. 3-3B in which like elements are provided having like reference numerals throughout the several views, an illustrative crossover bar 50, which may be suitable for use with antenna 22 described above in conjunction with FIGS. 2-2D, is provided from a conductive member having openings 52a, 52b provided in opposite ends thereof. A first one of the openings 52a, 52b is sized so as to accept a center conductor of a coaxial transmission line (e.g. one of center conductors 38a, 38b in FIG. 2C) and a second one of the openings 52a, 52b is sized so as to accept an end of a conductive rod (e.g. one of posts 42a, 42b). As can be seen in FIG. 3, crossover bar 50 is provided having a generally U-shape with an overall length LC1 and a center-to-center spacing S1 between holes 52a, 52b selected to match the center-to-center spacing between a center conductor of a coaxial transmission line and a post of a conductive rod.

In general, crossover bars may be provided having any size and shape which enables two crossover bars to be coupled to coaxial lines and conductive rods as shown in FIGS. 2-2D without coming into electrical contact with each other.

In an embodiment, an antenna provided in accordance with the concepts described herein was mounted on a fiberglass tower for gain pattern measurements. Absolute gain for vertical and horizontal polarization was determined by comparison with an ultrawideband (UWB) VHF dipole (2.25″ diameter with length 24″) fed with a 1:1 50 ohm transformer balun. Measured dipole mismatch loss was used to determine a calibration curve for this UWB dipole. Cable scattering effects were reduced by means of commercial multiple ferrite cores positioned along the coaxial feed line.

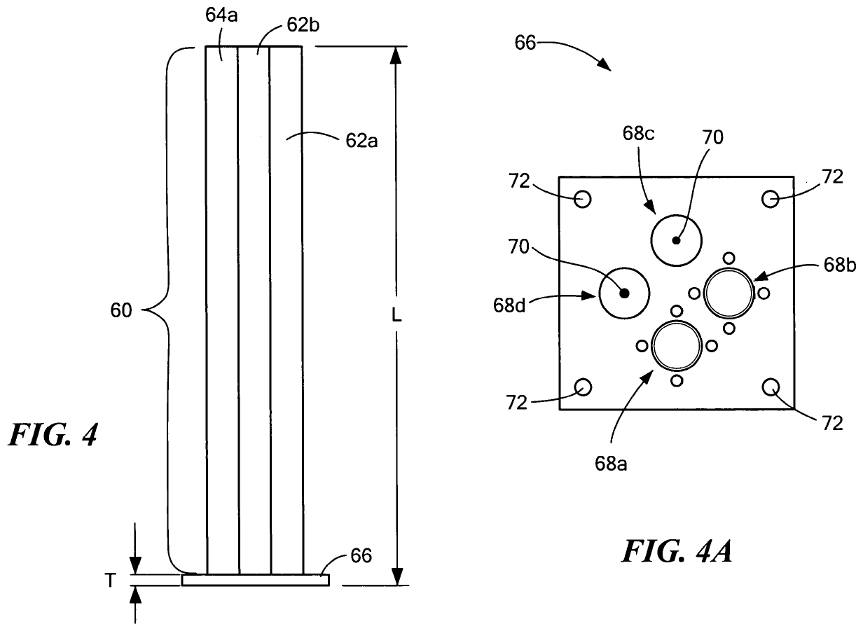

Referring now to FIGS. 4 and 4A in which like elements are provided having like reference designations, a folded balun 60, which may be the same as or similar to the folded balun described above in conjunction with FIGS. 2-2D, includes a pair of coaxial transmission lines 62a, 62b and a pair of conductive rods 64a, 64b (with only conductive rod 64a visible in FIG. 4) coupled to a mounting plate 66. In embodiments, the coaxial transmission line and conductive rods are press fit into respective ones of recesses 68a-68d provided in base 66. In embodiments, some or all of recesses 68a-68d may be provided having one or more threaded openings 70 provided therein to accept centrally located screws provided in ends of the conductive rods 64a, 64b. In embodiments, the conductive rods and outer jacket of the coaxial transmission lines are welded to the mounting plate. In embodiments, the conductive rods and outer jacket of the coaxial transmission lines are press fit into openings of the base plate (or directly into a ground plane) and welded (or otherwise secured) to the mounting plate. Other mounting techniques, may of course, also be used.

Mounting plate 66 further includes mounting holes 72 with which the mounting plate can be removably or permanently coupled to a ground plane.

Referring now to FIGS. 5-5C, in which like elements are provided having like reference designations, throughout the several views, with this antenna design four different linear polarizations can be generated. It should be noted that the differential mode of operation of this antenna is substantially the same as a crossed linear dipole or crossed bowtie dipole antenna. With the corners of loops 1 and 2 defining one port, a first linear polarization can be generated by driving the port in a differential (±) balanced mode for horizontal polarization.

In FIG. 5A, the central corners of loops 3 and 4 define one port which may be driven in a differential (±) balanced mode for vertical polarization.

With the balanced excitation shown in FIGS. 5B and 5C, slant left and slant right polarizations may be generated.

To achieve circular polarization, the two ports would be driven with a 90° phase difference e.g. using a phase shifter or a 90° hybrid coupler.

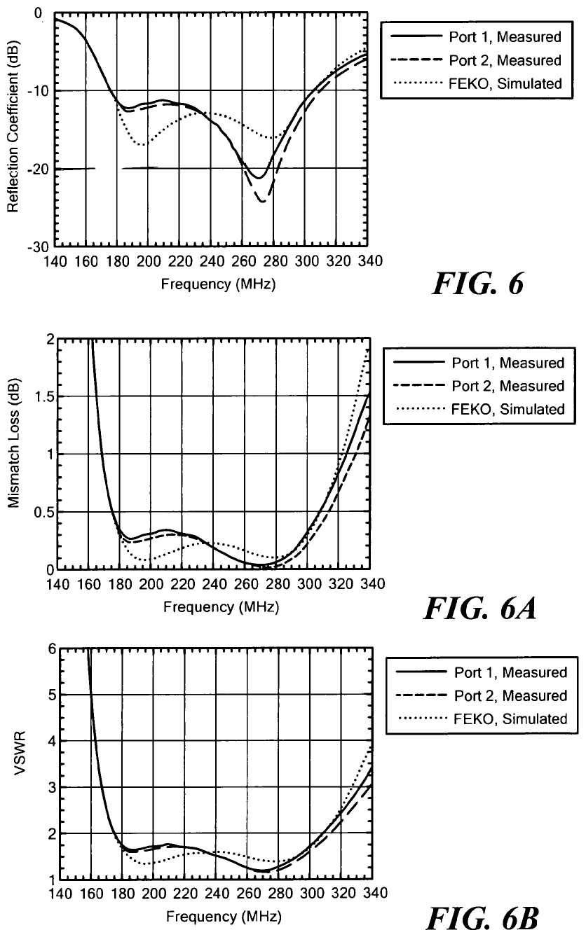

Referring now to FIGS. 6-6B, the measured and simulated reflection coefficient, mismatch loss, and VSWR versus frequency and shown for an antenna provided in accordance with the concepts described herein (e.g. as described in conjunction with FIGS. 2-5) , and good agreement is observed. The VSWR is less than 2.5:1 over the 170 MHz to 320 MHz band.

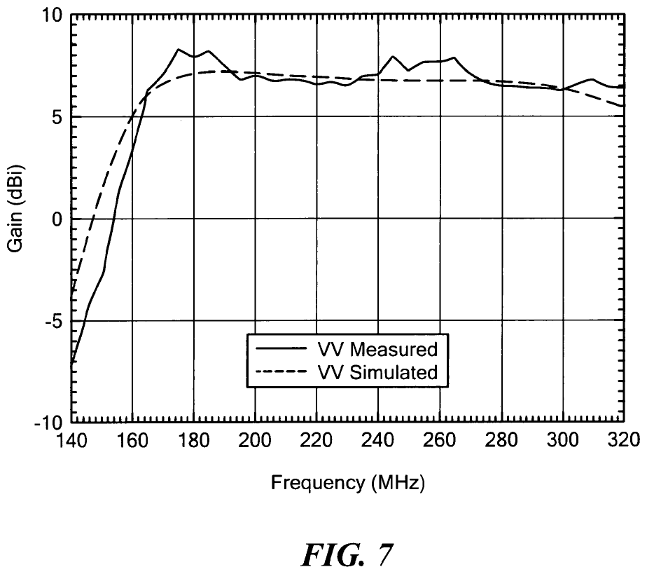

Referring now to FIG. 7, measured and simulated boresight gain (from H-plane data) versus frequency as shown for an antenna provided in accordance with the concepts described herein (e.g. as described in conjunction with FIGS. 2-5) and it is observed that good agreement is achieved between measured and simulated boresight gain. The measured gain is greater than about 6 dBi from 170 MHz to 320 MHz (61% bandwidth).

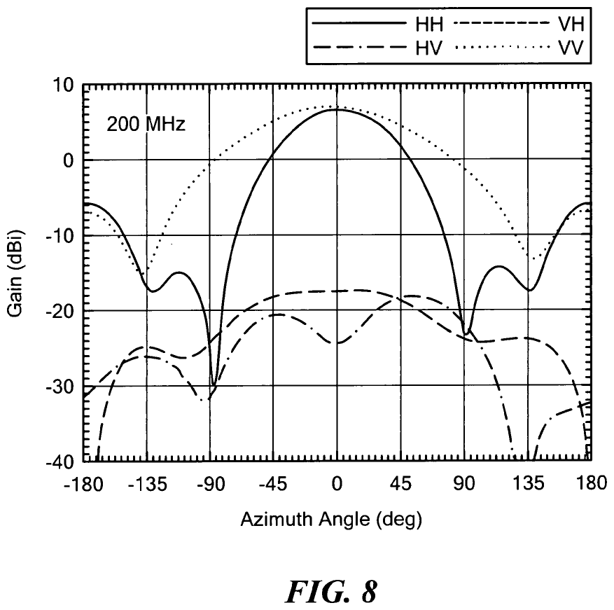

Referring now to FIG. 8, measured gain patterns for both vertical and horizontal polarizations including cross polarization at 200 MHz are shown for an antenna provided in accordance with the concepts described herein (e.g. as described in conjunction with FIGS. 2-5). At boresight where peak co-pol gain occurs, the measured cross polarization level is <−20 dB.

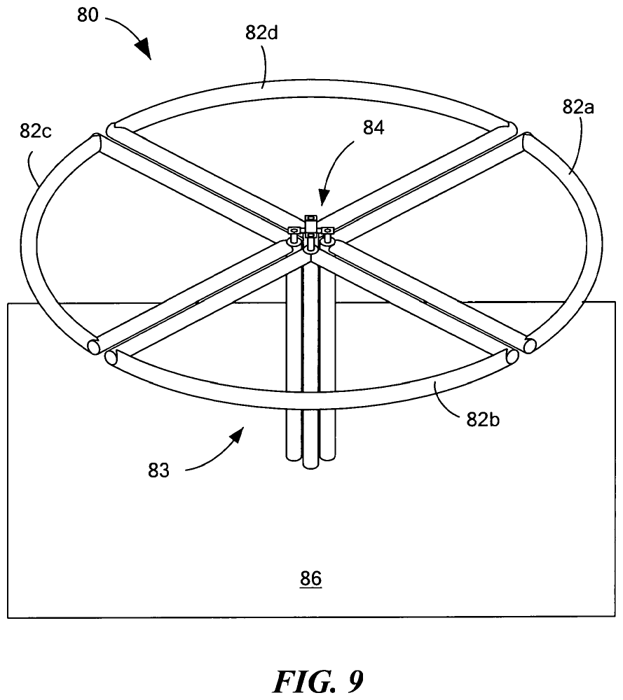

Referring now to FIG. 9, a wideband dual-polarized, four-quad-loop antenna 80 suitable for use at VHF in the 170 MHz to 320 MHz band comprises four pie-shaped loops 82a-82d. The loops 82a-82d are coupled to a pair of folded coaxial baluns 83 via a feed assembly 84. Feed assembly 84 may be the same as or similar to feed assembly 30 described above in conjunction with FIGS. 2-2D. The loops 80a-80d are driven in two independent pairs from the folded coaxial baluns 82.

Described herein is wideband dual-polarized, four-quad-loop antenna suitable for use in ground-based field testing at VHF in the 170 MHz to 320 MHz band (61% instantaneous bandwidth). Good performance is demonstrated with measured peak realized gain >6 dBi, VSWR <2.5:1, and cross polarization <−20 dB over this bandwidth.

In an embodiment, the antenna comprises four square loops fabricated from circular tubing. The loops are driven in two independent pairs from folded coaxial baluns. The antenna produces effectively the radiation patterns of a crossed dipole.

All publications and references cited herein are expressly incorporated herein by reference in their entirety.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

What is claimed is:

1. An antenna system comprising:
an electrically conducting ground plane;
a plurality of loop antenna elements disposed above a ground plane; and
a like plurality of folded coaxial balun transmission lines each having a first end with a center conductor electrically coupled to a corresponding one of said plurality of loop antenna elements and a second end having an outer conductor electrically coupled to one of said plurality of loop antenna elements and to said ground plane such that the antenna system is capable of transmitting and/or receiving radio frequency (RF) electromagnetic waves.

2. The system of claim 1, wherein said loop antenna elements are comprised of at least one of: electrically conducting wire; tube-shaped antenna elements; or strip antenna elements.

3. The system of claim 1, wherein said loop antenna elements have a perimeter approximately 0.7 wavelengths long at the center operating frequency of the system.

4. The system of claim 1, wherein the loop antenna elements have an approximate square or circular shape.

5. The system of claim 1, wherein the loop elements are provided from an electrically conductive material.

6. The system of claim 5, wherein the electrically conductive material is one of a conductive material such as: aluminum, brass, copper, steel, or bronze.

7. The system of claim 1, wherein said loop antenna elements are spaced approximately 0.25 wavelengths over the ground plane at the center operating frequency of the system.

8. The system of claim 1, wherein said dual folded coaxial baluns provide an impedance match from the transmission line to the loop antenna elements.

9. The system of claim 1, wherein said antenna system provides two orthogonal linear polarizations, which can be fed to produce a single linear polarization, circular polarization or elliptical polarization.

10. The system of claim 1, wherein said antenna system provides wide bandwidth operation.

11. The system of claim 1, wherein said antenna system provides high front to back ratio.

12. The system of claim 1, wherein said antenna system provides high polarization ratio for dual-polarization frequency reuse.

13. The system of claim 1, wherein said antenna system can be used in communications, radar, radio astronomy, and other sensing applications.

14. The system of claim 1 wherein said plurality of antenna elements are four antenna elements.

15. The system of claim 14 wherein said four antenna elements are four square-shaped or circular antenna elements.

16. The system of claim 15 wherein said plurality of dual folded coaxial baluns are two folded coaxial baluns with each of the folded baluns having a first end coupled to a corresponding one of the antenna elements and a second end coupled to one of said plurality of loop antenna elements and to said ground plane.

17. The system of claim 16 further comprising a pair of cross-connect feed member, each cross-connect member having a first end coupled to a center conductor of a first one of the four dual folded coaxial baluns and a second end coupled to a center conductor of a second different one of the four dual folded coaxial baluns such that said four-quad-loop antennas capable of being driven in two independent pairs from said folded coaxial baluns.

18. The system of claim 17 wherein said ground plane is provided as a mesh ground plane or a solid ground plane.

19. The system of claim 18 wherein said four-quad-loop antenna is configured for operation in the VHF frequency range with a center frequency of about 245 MHz and a bandwidth or about 150 MHz.
